(19) United States
(12) Patent Application Publication
(10) Pub. No.: US 2013/0072042 A1
(43) Pub. Date: Mar. 21, 2013

(54) Network connector and connector main body thereof

(71) Applicant: Hung Chang Liao, Dongguan City (CN)

(72) Inventor: Hung Chang Liao, Dongguan City (CN)

(21) Appl. No.: 13/235,374

(22) Filed: Sep. 17, 2011

(51) Int. Cl. H01R 24/00; H01R 13/447; H01R 13/648

(52) U.S. Cl. 439/142; 439/676; 439/607.01

(57) ABSTRACT

The present invention discloses a network connector and a connector main body of the network connector. The connector main body includes an insulating body and a terminal set installed in the insulating body. The insulating body includes a first accommodating cavity formed with a front opening and a bottom opening, a plug holding portion is integrally formed with a casing of an electronic device, a second accommodating cavity is formed in the plug holding portion, and the first accommodating cavity of the insulating body and the second accommodating cavity of the plug holding portion are vertically communicated to form a plug-connection port for a plug. By disposing the position of the plug holding portion on the casing, partial of the thickness of the bottom wall of the initial insulating body can be eliminated, so that the network connector can be minimized and more suitable for the thin electronic products.

### BACKGROUND OF THE INVENTION

1. Field of the Invention

The present invention relates to a technical field of a network connector, and in particular relates to a network connector combined to a casing to increase the space availability and a connector main body of the network connector.

2. Description of the Related Art

RJ-45 connectors have been widely used in computers, electronic communication devices such as mobile phones, coupled by corresponding RJ-45 plugs so as to obtain a stable signal transmission.

As shown in FIG. 1, an assembling structure of a representative RJ-45 connector in conventional arts is illustrated. The RJ-45 connector, installed on a circuit board 40′ of a casing 10′, includes a shielding case body, an insulating body 20′ integrally formed with a plug holding portion 70′, and a terminal set 30′. Actually, this RJ-45 connector still has some defects unsuitable for the requirement of the thin electronic products, for example, the size of the RJ-45 connector is large, and a low space availability caused by the entire thickness of the electronic product including the thickness of the bottom wall of the plug holding portion 70′. Furthermore, because a plug-connection port 50′ of the network connector is outwardly exposed, the appearance of the network connector is inartistic, and the substance such as dust is tended to enter the interior of the network connector via the plug-connection port 50′ to damage the inner components thereof.

Therefore, it is essential to develop a new technical project to overcome the above-described difficulties in the conventional skills.

### BRIEF SUMMARY OF THE INVENTION

In view of this, the main purpose of the present invention is to provide a network connector and a connector main body thereof to increase the space availability.

To achieve the purposes above, the present invention is adopted with the technology projects as follows.

A network connector installed on a circuit board disposed in a casing of an electronic product, comprising a connector main body. The connector main body includes an insulating body and a terminal set installed in the insulating body. The insulating body includes a first accommodating cavity formed with a front opening and a bottom opening, a plug holding portion is integrally formed with the casing of the electronic device, a second accommodating cavity is formed in the plug holding portion, and the first accommodating cavity of the insulating body and the second accommodating cavity of the plug holding portion are vertically communicated to form a plug-connection port for inserting a plug.

A connector main body of a network connector comprises an insulating body and a terminal set installed in the insulating body. The insulating body comprises a left wall, a right wall, a top wall and a rear end wall, and an accommodating cavity is inwardly surrounded by the left wall, the right wall, the top wall and the rear end wall to be formed with a front opening and a bottom opening.

Concretely speaking, it is understood that the present invention provides the following advantages and beneficial effects in accordance with the above-described technology projects, compared to the conventional skills

By altering the position of the plug holding portion to the casing, compared to the plug holding portion located on the insulating body in the conventional skills, partial of the thickness of the bottom wall of the initial insulating body can be eliminated, so that the network connector can be minimized and more suitable for the thin electronic products. Meanwhile, because the plug holding portion and the initial insulating body are split for assembling, the high-temperature manufacturing process required by the integral formation of the plug holding portion and the insulating body in the conventional skills can be omitted, so that the plug holding portion of the present invention can be coated in any process.

By disposing the plug holding portion on the cover, the plug-connection port is exposed for inserting the plug when the cover is opened, and the plug-connection port is shielded and the inner components of the network connector can be protected from damage when the cover is closed. Herewith, the appearance of the network connector is artistic, and the network connector can provide an ideal space availability in the actual application.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a perspective schematic view of an assembling structure of a representative RJ-45 connector in conventional arts;

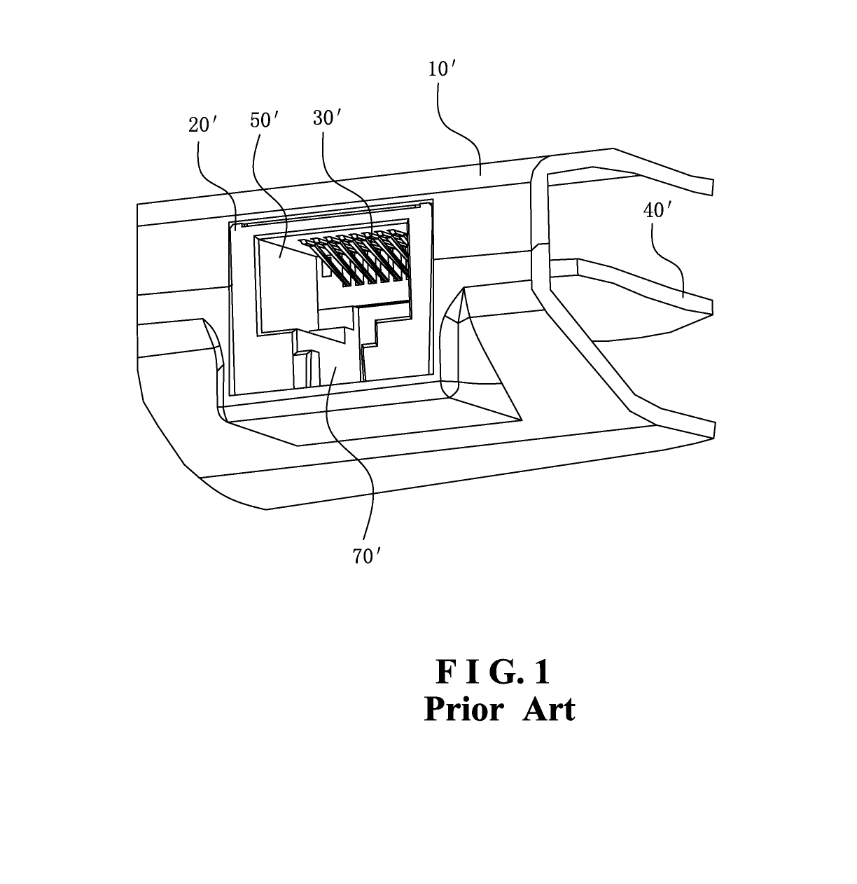

FIG. 2 is a perspective schematic view of an assembling structure of a first embodiment of the present invention;

FIG. 3 is a perspective schematic view of an exploded structure of a first embodiment of the present invention;

FIG. 4 is a schematic view of a second embodiment of the present invention, wherein a plug-connection port is covered;

FIG. 5 is a schematic view of a second embodiment of the present invention, wherein a plug-connection port is opened for insertion;

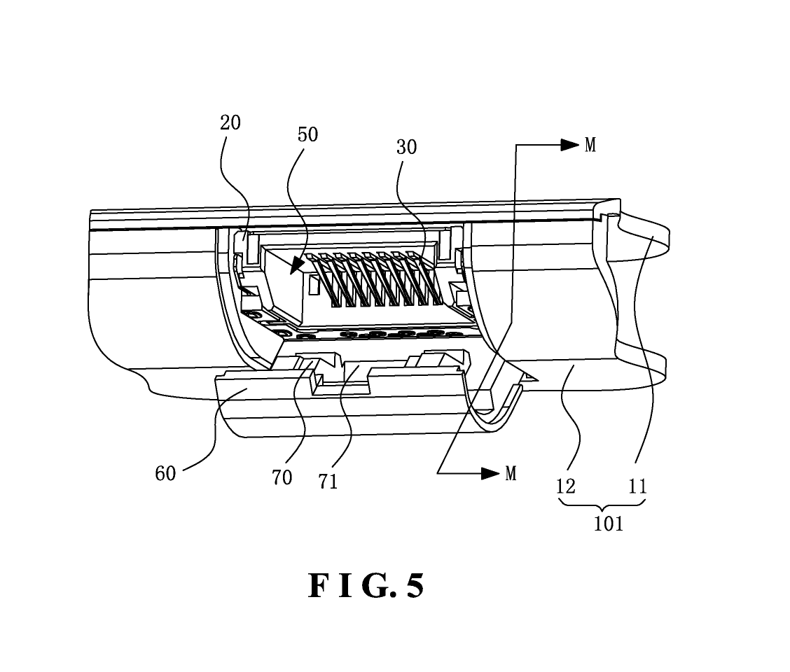

FIG. 6 is a perspective schematic view of an exploded structure of a second embodiment of the present invention;

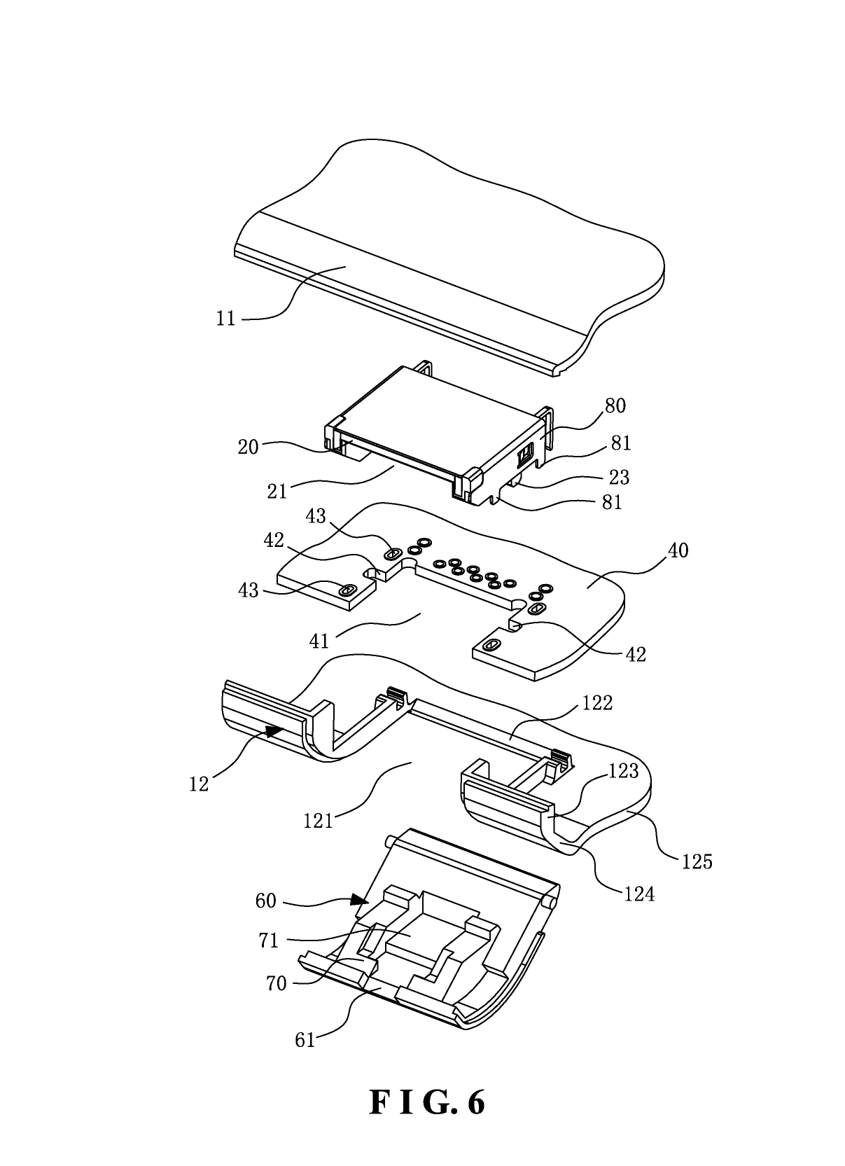

FIG. 7 is an enlarged schematic view of a section of line M-M in FIG. 5.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

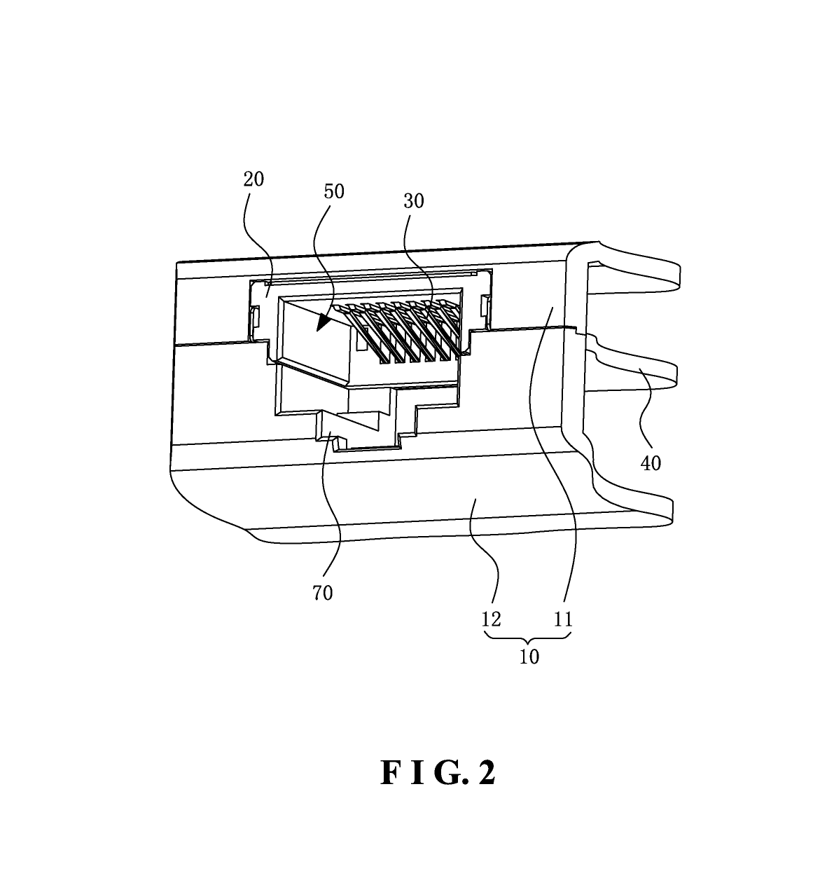

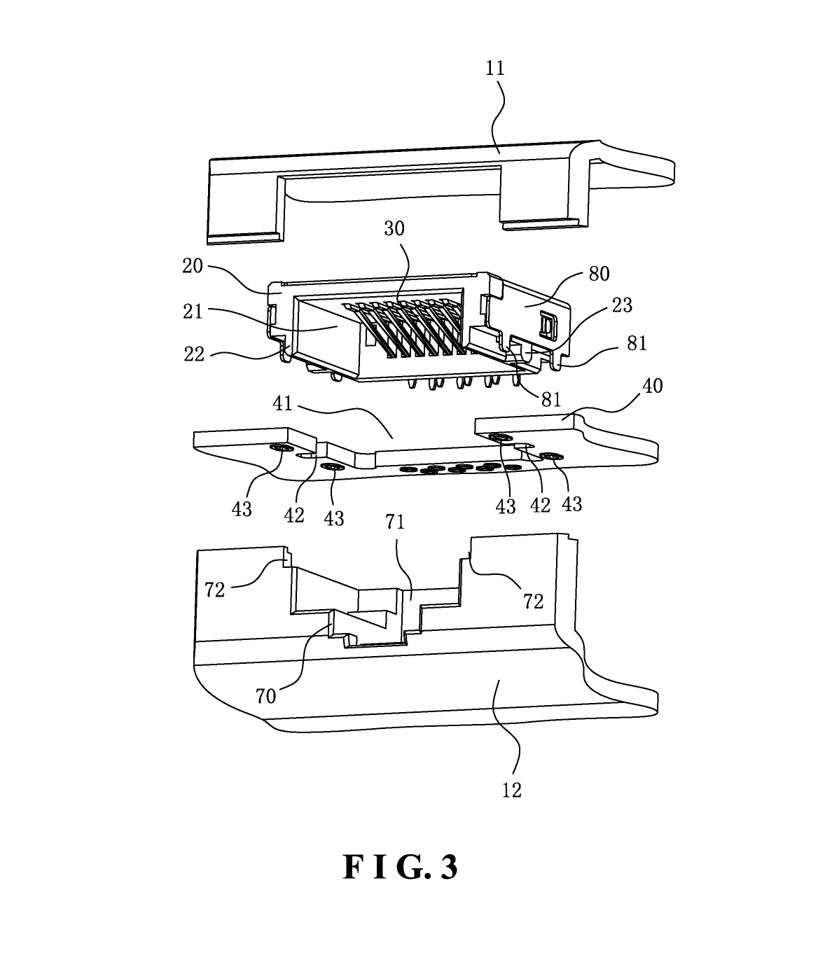

Referring to FIGS. 2 and 3, a physical structure of a first embodiment of the invention is illustrated, taking a RJ-45 connector for example for explanation. The RJ-45 connector is a network connector installed on a circuit board 40 disposed in a casing 10 of an electronic product and comprising a connector main body. The connector main body of the network connector includes an insulating body 20 and a terminal set 30 installed in the insulating body 20.

The insulating body 20 includes a left wall, a right wall, a top wall and a rear end wall, wherein a first accommodating cavity 21 is inwardly surrounded by the left wall, the right wall, the top wall and the rear end wall to be formed with a front opening and a bottom opening. A holding wall 22 is integrally formed with and downwardly extended from a bottom surface at both sides of the insulating body 20 of the connector main body, or the holding wall 22 is integrally formed with and downwardly extended from a periphery of the bottom opening of the first accommodating cavity 21 of the insulating body 20 of the connector main body, and a position-limiting block 23 is outwardly projected from the holding wall 22 of the insulating body 20. A contact end of the terminal set 30 is exposed by an inner wall surface of the top wall of the insulating body 20, and a welded end of the terminal set 30 is outwardly extended from the rear end wall of the insulating body 20 and downwardly bent and extended. A plug holding portion 70 is integrally formed with the casing 10 of the electronic device, a second accommodating cavity 71 is formed in the plug holding portion 70, and a position-limiting step 72 is formed on a top end of the plug holding portion 70.

The circuit board 40 is located between the insulating body 20 of the connector main body and the plug holding portion 70, the circuit board 40 includes an installation notch 41 corresponding to the bottom opening of the first accommodating cavity 21 of the insulating body 20, and a position-limiting slot 42 corresponding to the position-limiting block 23 of the insulating body 20 is outwardly recessed from an inner wall surface of the installation notch 41 of the circuit board 40. In assembling process, the holding wall 22 of the insulating body 20 is embedded in the installation notch 41 of the circuit board 40 and is downwardly embedded to an inner side of the position-limiting step 72 of the plug holding portion 70, the position-limiting block 23 of the insulating body 20 is correspondingly engaged in the position-limiting slot 42 of the circuit board 40, and a bottom surface of the insulating body 20 of the connector main body is abutted against the circuit board 40. The first accommodating cavity 21 of the insulating body 20 and the second accommodating cavity 71 of the plug holding portion 70 are vertically communicated to form a plug-connection port 50 for inserting a plug.

The network connector further comprises a shielding case body 80 utilized to enclose the periphery of the insulating body 20, fastening legs 81 are downwardly extended from two sidewalls of the shielding case body 80, fastening holes 43 corresponding to the fastening legs 81 of the shielding case body 80 are formed on the circuit board 40, and the fastening legs 81 of the shielding case body 80 are embedded in the fastening holes 43 of the circuit board 40.

In this embodiment, the casing 10 comprises a upper casing 11 and a lower casing 12 which are connected to each other, the plug holding portion 70 is integrally formed with the lower casing 12 of the casing 10, so that the entire volume of the network connector can be reduced, and the high-temperature manufacturing process required by the integral formation of the plug holding portion and the insulating body in the conventional skills can be omitted. Note that the plug holding portion 70 can be coated in any process.

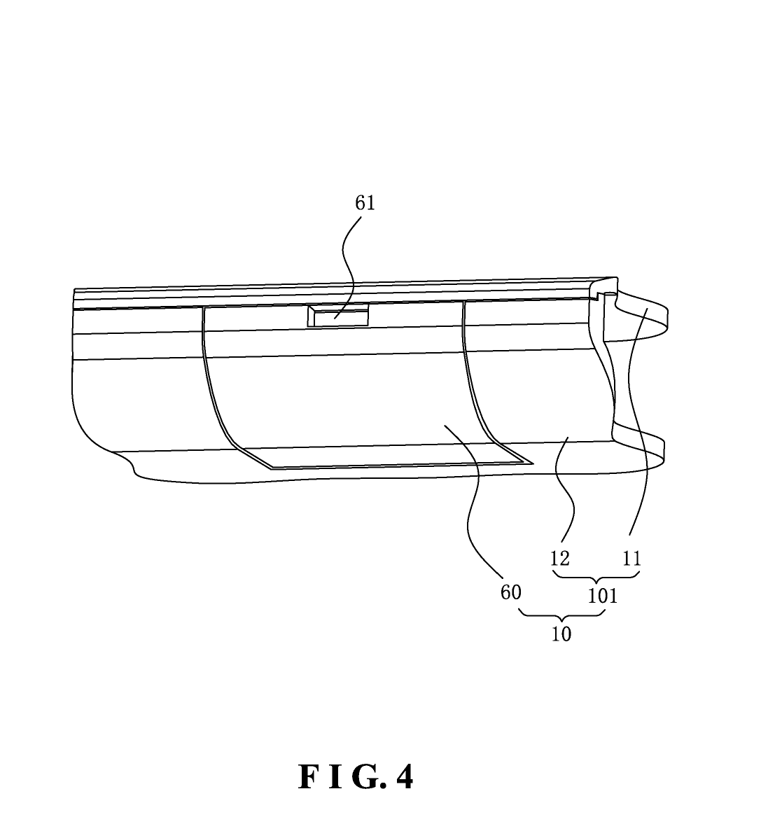

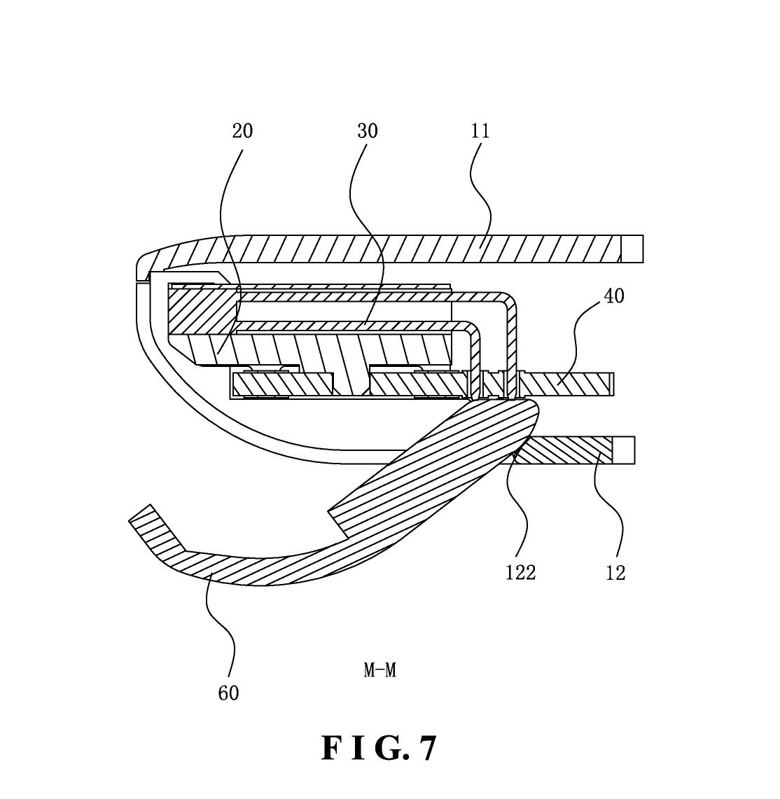

Referring to FIGS. 4 and 7, a physical structure of a second embodiment of the invention is illustrated. The network connector of the second embodiment also provides the plug holding portion 70 to be integrally formed with the casing 10. The network connector of the second embodiment differs from that of the first embodiment in that the casing 10 comprises a casing main body 101 and a cover 60 pivotally connected to the casing main body 101, the casing main body 101 comprises the upper casing 11 and the lower casing 12, wherein the lower casing 12 comprises an integrally-formed front wall plate 123, a base plate 125 and an arc connecting plate 124 disposed between the front wall plate 123 and the base plate 125, the front wall plate 123 and the arc connecting plate 124 are jointly disposed with an opening 121 which faces the first accommodating cavity 21 of the insulating body 20 and the installation notch 41 of the circuit board 40, the cover 60 having a shape matching to that of the opening 121 of the casing main body 101 is installed on the opening 121 of the casing main body 101, and the plug holding portion 70 is integrally formed with the cover 60 of the casing 10.

When the cover 60 of the casing 10 is downwardly and rotatorily opened, the first accommodating cavity 21 of the insulating body 20 and the second accommodating cavity 71 of the plug holding portion 70 are matched so as to form the plug-connection port 50. When the plug is removed, the cover 60 of the casing 10 is upwardly and rotatorily closed to fully cover the front opening and the bottom opening of the first accommodating cavity 21 of the insulating body 20, and the outer surface of the cover 60 is in registered with the outer surface of the lower casing 12 of the casing main body 101, therewith the appearance of the network connector can be straight and artistic. In order to normally rotate the cover 60, a snap joint can be provided on the cover 60. In this embodiment, the snap joint is a snap hole 61.

In addition, the casing 10 is disposed with a position-limiting surface 122 in accordance with the cover 60 of the casing 10, and the cover 60 of the casing 10 is stopped on the position-limiting surface 122 of the casing 10 in state of nature when the cover 60 of the casing 10 is downwardly and rotatorily opened (as shown in FIG. 7).

What is claimed is:

1. A network connector installed on a circuit board disposed in a casing of an electronic product, comprising a connector main body, the connector main body including an insulating body and a terminal set installed in the insulating body, characterized in that the insulating body includes a first accommodating cavity formed with a front opening and a bottom opening, a plug holding portion is integrally formed with the casing of the electronic device, a second accommodating cavity is formed in the plug holding portion, and the first accommodating cavity of the insulating body and the second accommodating cavity of the plug holding portion are vertically communicated to form a plug-connection port for inserting a plug.

2. The network connector as claimed in claim 1, characterized in that the circuit board is located between the insulating body of the connector main body and the plug holding portion, and the circuit board includes an installation notch corresponding to the bottom opening of the first accommodating cavity of the insulating body.

3. The network connector as claimed in claim 2, characterized in that a position-limiting step is formed on a top end of the plug holding portion, a holding wall is integrally formed with and downwardly extended from a periphery of the bottom opening of the first accommodating cavity of the insulating body to embed in the installation notch of the circuit board and to downwardly embed to an inner side of the position-limiting step of the plug holding portion, and a bottom surface of the insulating body of the connector main body is abutted against the circuit board.

4. The network connector as claimed in claim 3, characterized in that a position-limiting block is outwardly projected from the holding wall of the insulating body, a position-limiting slot corresponding to the position-limiting block of the insulating body is outwardly recessed from an inner wall surface of the installation notch of the circuit board, and the position-limiting block of the insulating body is correspondingly engaged in the position-limiting slot of the circuit board.

5. The network connector as claimed in claim 1, characterized in that the network connector further comprises a shielding case body utilized to enclose the periphery of the insulating body, a fastening leg is downwardly extended from two sidewalls of the shielding case body, a fastening hole corresponding to the fastening leg of the shielding case body is formed on the circuit board, and the fastening leg of the shielding case body is embedded in the fastening hole of the circuit board.

6. The network connector as claimed in claim 1, characterized in that the casing comprises a casing main body and a cover pivotally connected to the casing main body, the casing main body is disposed with an opening facing the first accommodating cavity of the insulating body, the cover having a shape matching to that of the opening of the casing main body is installed on the opening of the casing main body, and the plug holding portion is integrally formed with the cover of the casing;
wherein the first accommodating cavity of the insulating body and the second accommodating cavity of the plug holding portion are matched so as to form the plug-connection port when the cover of the casing is downwardly and rotatorily opened, and the cover of the casing covers the front opening and the bottom opening of the first accommodating cavity of the insulating body when the cover of the casing is upwardly and rotatorily closed.

7. The network connector as claimed in claim 6, characterized in that the casing main body of the casing comprises a upper casing and a lower casing which are connected to each other, the lower casing of the casing main body is disposed with the opening, and the cover is pivoted to the lower casing of the casing main body, wherein an outer surface of the cover is in registered with an outer surface of the casing when the cover of the casing is upwardly rotated to fully cover the first accommodating cavity of the insulating body.

8. The network connector as claimed in claim 6, characterized in that the casing is disposed with a position-limiting surface in accordance with the cover of the casing, and the cover of the casing is stopped on the position-limiting surface of the casing in state of nature when the cover of the casing is downwardly and rotatorily opened.

9. A connector main body of a network connector, comprising an insulating body and a terminal set installed in the insulating body, characterized in that the insulating body comprises a left wall, a right wall, a top wall and a rear end wall, and an accommodating cavity is inwardly surrounded by the left wall, the right wall, the top wall and the rear end wall to be formed with a front opening and a bottom opening.

10. The connector main body of the network connector as claimed in claim 9, characterized in that a contact end of the terminal set is exposed by an inner wall surface of the top wall of the insulating body, and a welded end of the terminal set is outwardly extended from the rear end wall of the insulating body and downwardly bent and extended.
